(19) United States
(12) Patent Application Publication
(10) Pub. No.: US 2026/0334381 A1
(43) Pub. Date: Oct. 29, 2026

(54) DEVICE, SYSTEM AND METHODS FOR PROCESSING PLANT CUTTINGS

(71) Applicant: TUINBOUW TECHNISCH ATELIER (TTA) B.V., Bleskensgraaf (NL)

(72) Inventors: Egbert FREDRIKZE, Bleskensgraaf (NL); Jacob Dirk Steven DE GROOT, Bleskensgraaf (NL)

(21) Appl. No.: 19/485,936

(22) PCT Filed: Jun. 7, 2024
(86) PCT No.: PCT/NL2024/050302

§ 371 Date: Nov. 19, 2025

(30) Foreign Application Priority Data
Jun. 9, 2023 (NL) 2035065
Nov. 15, 2023 (NL) 2036276

(51) Int. Cl. A01G 9/08

(52) U.S. Cl. CPC A01G 9/083

(57) ABSTRACT

A device for processing plant cuttings, a system, and a method, include a gripper including gripping fingers for gripping, holding and releasing a plant cutting; a first guide element positioned on a first outer side of the gripper; and a second guide element positioned on a second outer side of the gripper opposite the first outer side. The device is configured to displace the first guide element and the gripping fingers of the gripper relative to each other, and to displace the second guide element and the gripping fingers of the gripper relative to each other independently thereof.

This description relates to a device for processing plant cuttings, a system for processing plant cuttings comprising such a device, the use of such a system or device, and methods for processing, for instance picking up and/or placing, plant cuttings.

In the horticultural sector there is a need for automatic processing of plant cuttings. There is particularly a need for better systems for automatically picking up plant cuttings and placing them in a ground.

Automatic picking up and placing of plant cuttings entails numerous technical problems. It is for instance difficult to pick up a lying plant cutting with a gripper, and particularly to pick up this plant cutting in a predictable and/or controllable orientation so that it can be placed in the correct orientation. It is further difficult to pick up a plant cutting without damaging it. It is additionally difficult to place a plant cutting in a ground and then release it without the positioning of the plant cutting changing or the plant cutting remaining stuck to the gripper.

Existing systems for automatically picking up and placing in a ground of plant cuttings are unable to solve these problems completely.

In an example of an existing system for picking up and setting down plant cuttings a gripper is applied which is provided with two elongate gripping fingers in which a stop which supports the plant cutting is present between two gripping surfaces of the gripping fingers. This system still has problems. Said system particularly does not prevent vulnerable parts of a gripped plant cutting from becoming damaged, for instance due to ending up between the gripping fingers and the stop.

It is an object to at least reduce at least some of the above stated problems.

It is a further object to provide a better approach for automatically processing vulnerable part of plant cuttings.

It is yet another object to provide an approach for automatically processing plant cuttings, wherein more precise control of the picking up and placing is possible.

In a first aspect at least one of these objects is achieved in a device for processing plant cuttings, comprising a gripper comprising gripping fingers for gripping, holding and releasing a plant cutting; a first guide element positioned on a first outer side of the gripper; and a second guide element positioned on a second outer side of the gripper opposite the first outer side, wherein the device is configured to displace the first guide element and the gripping fingers of the gripper relative to each other, and to displace the second guide element and the gripping fingers of the gripper relative to each other independently thereof.

The use of two separate guide elements enables the device to be controlled very precisely when gripping, holding and releasing a plant cutting. It is possible to influence the positioning of portions of a plant cutting for orientation, protection and/or positioning of the plant cutting.

A number of further advantages are as follows. The risk of a plant cutting inadvertently becoming stuck in the gripper is further reduced during picking up and displacing. A further advantage is that when a plant cutting is picked up, it can be pressed down onto a pick-up surface if necessary. In determined situations it is for instance advantageous to displace the guide element no further than a predetermined (limited) distance above the ground. An additional advantage is that the sliding away (displacing away) of the guide element can here be postponed until a moment when the plant cutting has already been released.

It is not essential for the device to be configured to rotate the gripper in a vertical plane (XY plane).

In determined embodiments the gripping fingers lie opposite each other in a first dimension; wherein the first guide element and the second guide element are situated on the outer side of the gripper in a second dimension, which lies substantially at right angles to the first dimension; and wherein the device is configured to move the first guide element and the second guide element, independently of each other, and the gripper relative to each other in a third dimension which lies substantially at right angles to the first dimension and the second dimension.

By holding the plant cutting, screening off the remaining space for movement of the plant cutting and displacing the plant cutting in different directions an optimal configuration is achieved.

Determined embodiments are further configured to displace the gripping fingers in the first dimension between a closed position for gripping and holding the plant cutting and an opened position for releasing the plant cutting.

Determined embodiments further comprise an actuator, for instance a pneumatic or hydraulic actuator or electric cylinder, to displace the gripping fingers between the closed position and the opened position.

Determined embodiments further comprise a limiter for limiting the displacement in the first dimension of at least one of the gripping fingers for the purpose of limiting the distance between the gripping fingers in the opened position.

In determined embodiments the limiter is mounted at a fixed position relative to the second guide element.

For processing of plant cuttings it is advantageous to use an actuator which can operate at high speed, does not malfunction easily and requires little maintenance, such as a pneumatic actuator. In use of determined types of actuator it is more efficient to configure the device with a limiter for stopping movements than to attempt to control the position of the element moved by the actuator in detail.

In determined embodiments the gripper comprises two gripping fingers which are provided at their outer end with respective surfaces for gripping and holding therebetween a plant cutting resting on a ground, wherein the surfaces are preferably flat or are provided with a cavity for receiving a plant stem of a plant cutting gripped by the gripping fingers.

A gripper can comprise two or more elements for gripping and holding the plant cutting. Such elements are also referred to as fingers. The holding can be done by means of surfaces of the fingers which enclose the plant cutting from multiple directions. The use of two fingers lying directly opposite each other with two respective surfaces lying directly opposite each other is advantageous.

In determined embodiments the first guide element and/or the second guide element comprises a substantially flat plate which is provided with an elongate resting edge.

In determined embodiments an outer end of the first guide element and/or an outer end of the second guide element is wider than the distance between the gripping fingers when the gripper is in opened position.

A guide element can be embodied as a plate which is configured to slide along the gripping fingers. A plate is understood to mean an element comprising substantially a flat surface. It is advantageous for an outer end of such a plate to be configured at the free outer end of the device to close the space between the gripping fingers in order to stop portions of plant cuttings.

Determined embodiments the gripper is configured to grip plant cuttings from a substantially flat, firm pick-up surface.

It is advantageous during picking up for the surface to be predictable and not to co-displace, for instance in the form of a table or conveyor belt.

In determined embodiments the first guide element is configured to separate a first outer end of the plant cutting, for instance foliage of the plant cutting, from the gripping fingers when the gripper grips the plant cutting.

The stopping can prevent damage to the plant cutting or a portion thereof.

In determined embodiments the second guide element is configured to rotate and/or displace a second outer end of the plant cutting, and/or to prevent rotation and/or displacement of the second outer end, when the gripper grips a plant cutting.

Orienting the plant cutting or a portion thereof predictably and/or controllably can aid in holding the plant cutting and/or placing it in the ground.

Determined embodiments are configured to place a plant cutting in a ground, for instance a grow medium such as soil, by pressing the gripper into the ground while the gripper holds the plant cutting.

Determined embodiments are further configured to move the first guide element relative to the gripper when the gripper has placed the plant cutting in a ground for the purpose of stopping the plant cutting while the gripper moves away from the plant cutting.

In determined embodiments moving the first guide element relative to the gripper in order to stop the plant cutting comprises of holding the first guide element at a substantially fixed position relative to the ground while the gripper moves away from the ground.

In determined embodiments holding the first guide element at a fixed position relative to the ground comprises of making an outer end of the first guide element support on and/or push against the plant cutting, the ground and/or a ground container.

During movement of the gripper away from the ground the plant cutting or a portion thereof must preferably be prevented from co-displacing or being unintentionally displaced or rotated in other manner. This can for instance be done by holding the first guide element still against the plant cutting, the ground and/or a container of the ground and/or by holding the first guide element at a fixed position, for instance by synchronization with a base element and gripper which are moving away.

In determined embodiments a resting edge of the first guide element is configured to limit or prevent damage to plant cuttings in that the resting edge is rounded; and/or in that the resting edge is embodied at least partially in a flexible material, and/or in that the resting edge is provided with a recess for receiving a portion of a plant cutting.

In order to prevent vulnerable portions of the plant cutting, such as foliage, from being damaged because too much pressure is exerted thereon it is advantageous for the first guide element to be embodied such that the pressure which is exerted on the plant cutting is concentrated as little as possible on a small surface area.

Determined embodiments further comprise a base element on which the gripper, the first support element and the second support element are mounted.

Determined embodiments are further configured to place the gripping fingers round the plant cutting prior to the plant cutting being gripped and/or to move the gripper away from the plant cutting after the plant cutting has been released, by moving the gripper relative to the base element, and/or moving the gripper by moving the base element and simultaneously holding the gripper in a fixed position relative to the base element.

Determined embodiments are further configured to displace the gripper and at least one of the guide elements relative to each other by moving a guide element relative to the base element and simultaneously holding the gripper in a fixed position relative to the base element; and/or moving the gripper relative to the base element and simultaneously holding the guide element in a fixed position relative to the base element, and/or moving the gripper relative to the base element and simultaneously moving the guide element relative to the base element.

As will be further elucidated below, different configurations can be envisaged for mutually attaching the different components of the device and moving them relative to each other.

In determined embodiments processing of a plant cutting comprises of picking up a plant cutting resting on a pick-up surface and placing the picked-up plant cutting in a ground.

A second aspect comprises a system for processing plant cuttings, for instance a cutting insertion machine, comprising at least one device as described above mounted thereon, which is mounted on a displacing means for displacing the device between a pick-up position and a destination position.

A third aspect comprises the use of a system or device as described above.

A fourth aspect comprises a method for picking up a plant cutting by means of a device, preferably a device as described above, comprising of: positioning the gripping fingers of the device on either side of a plant cutting; positioning a first guide element of the device on a first outer side of the gripper in order to separate a first outer end of the plant cutting from the gripping fingers; positioning a second guide element of the device on a second outer side of the device in order to rotate and/or displace the second outer end, and/or to prevent rotation and/or displacement of the second outer end; and of closing the gripper.

During picking up the first outer side is the underside of the gripper and the second side is the upper side in determined embodiments, so that the first guide element is held along the bottom and the second guide element along the top of at least a portion of the gripping fingers.

With such a method the orientation of the plant cutting or portions thereof can be controlled in detail and damage to vulnerable portions of the plant cutting can be prevented at the same time.

A fifth aspect comprises a method for placing a plant cutting in a ground by means of a device, preferably a device as described above, comprising of pressing a gripper of the device into the ground while the gripper holds the plant cutting; opening the gripper; and moving the gripper out of the ground and away from the plant cutting, and simultaneously displacing the gripper and a first guide element relative to each other for the purpose of stopping the plant cutting with the first guide element.

Determined embodiments further comprise of moistening the ground, preferably of saturating the ground with moisture, prior to pressing the gripper into the ground.

A sixth aspect comprises of repeatedly performing a method for picking up as described above and a method for placing as described above.

There follows hereinbelow a more detailed description with reference to the following figures.

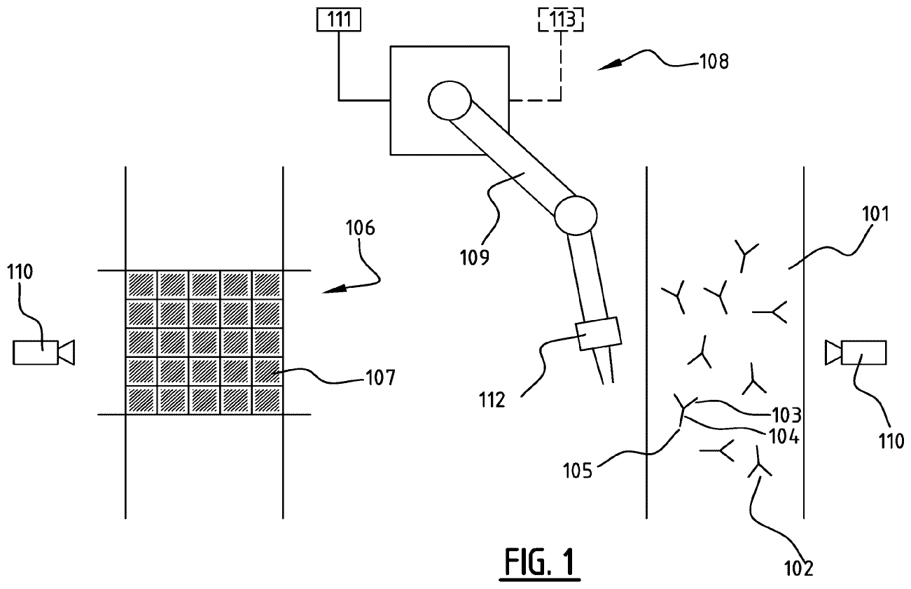

FIG. 1 shows an embodiment of a system for processing plant cuttings.

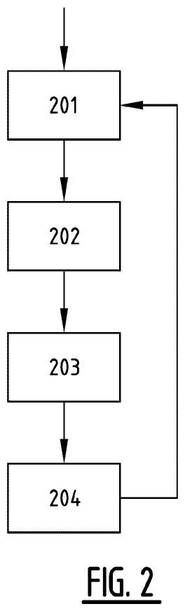

FIG. 2 shows an embodiment of a method for processing plant cuttings.

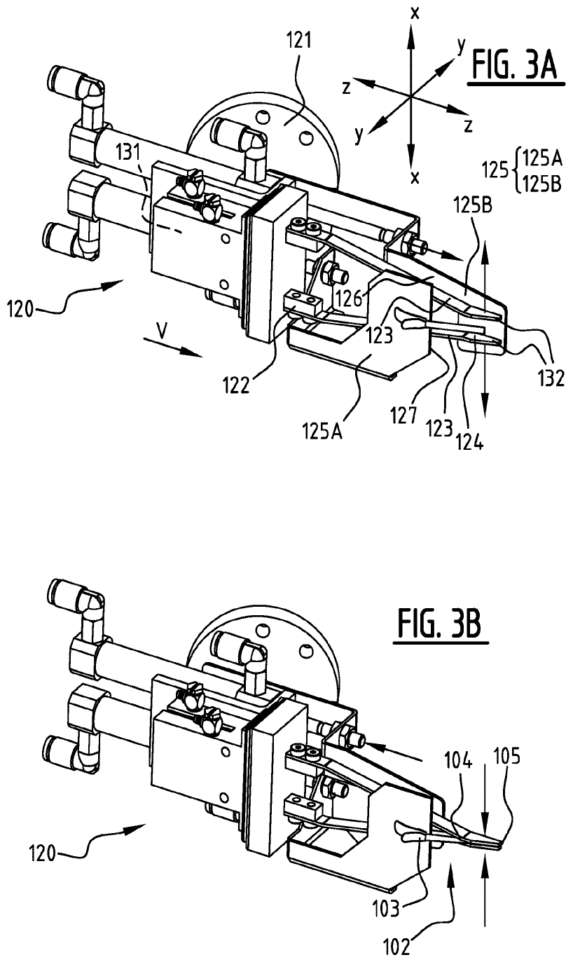

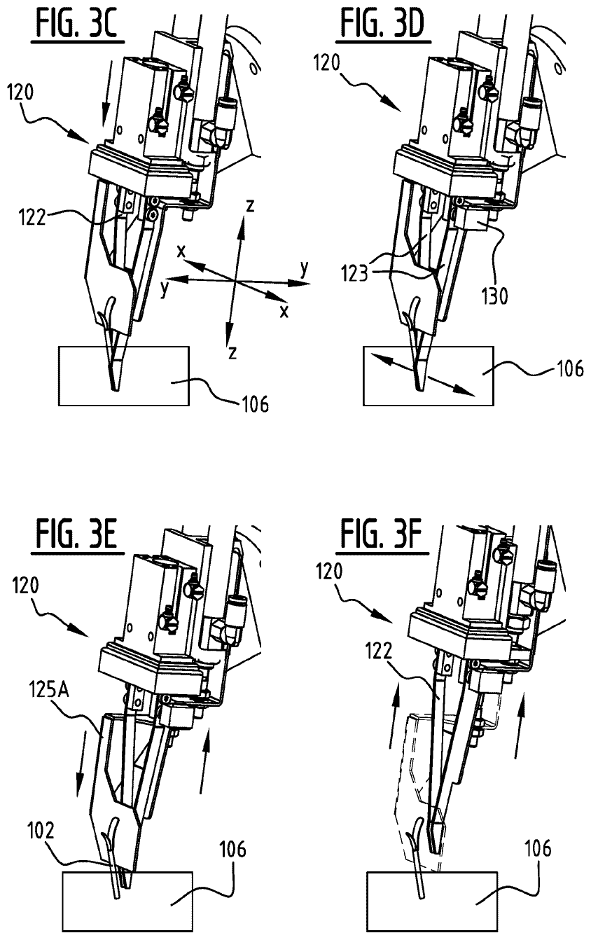

FIGS. 3A-F show embodiments of a device for processing plant cuttings during a method for processing plant cuttings.

FIGS. 4A-B show embodiments of a guide element for a device for processing plant cuttings.

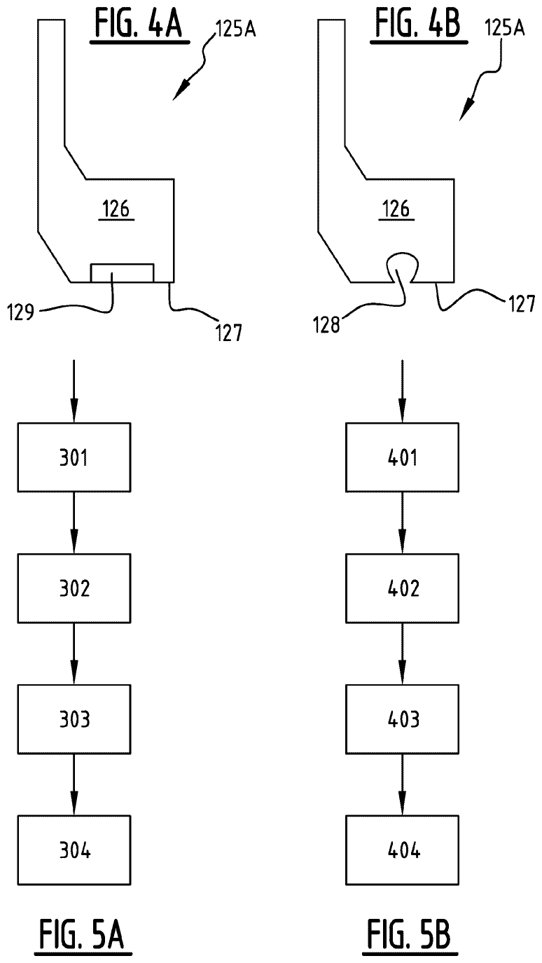

FIGS. 5A-B show embodiments of a method for processing plant cuttings.

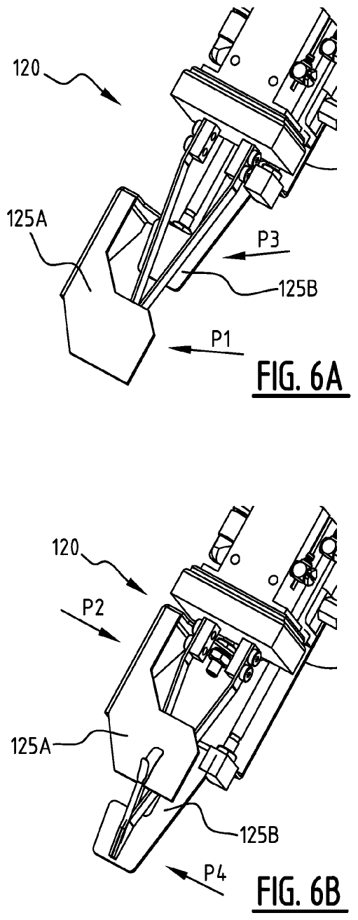

FIGS. 6A-B show embodiments of a device for processing plant cuttings, wherein guide means are positioned in determined positions relative to the gripper.

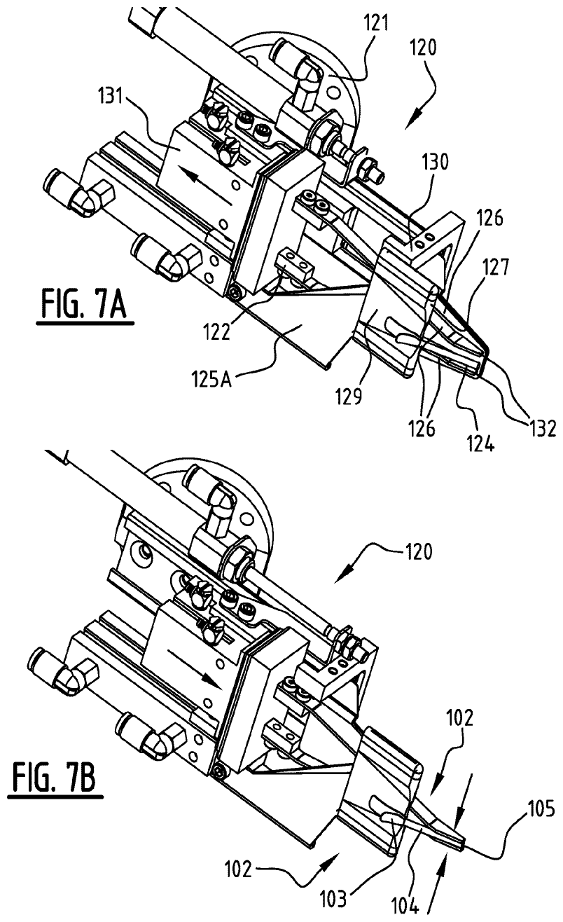

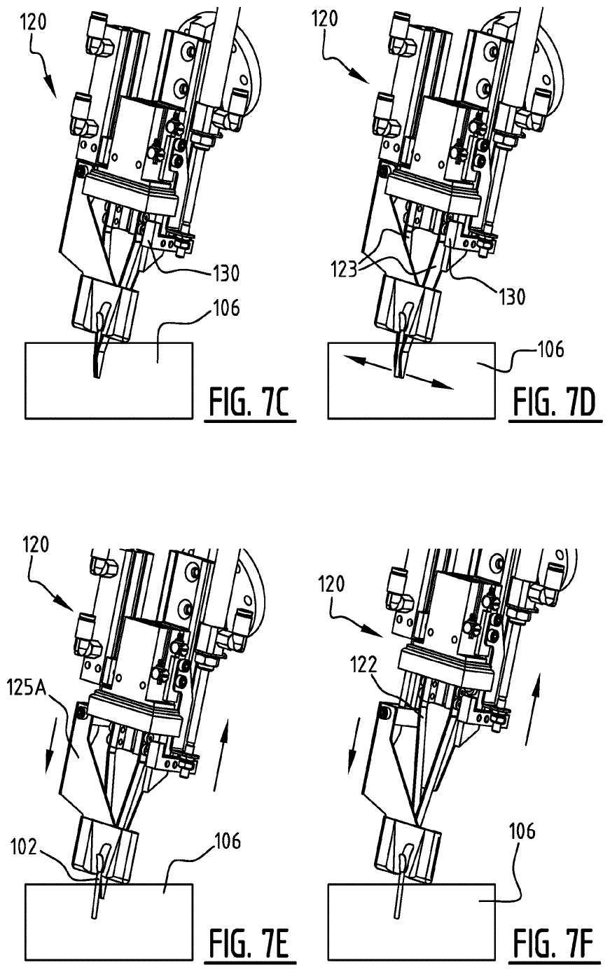

FIGS. 7A-F show alternative embodiments of a device for processing plant cuttings during a method for processing plant cuttings. A resting surface and a limiter are here particularly embodied differently than in FIGS. 3A-F.

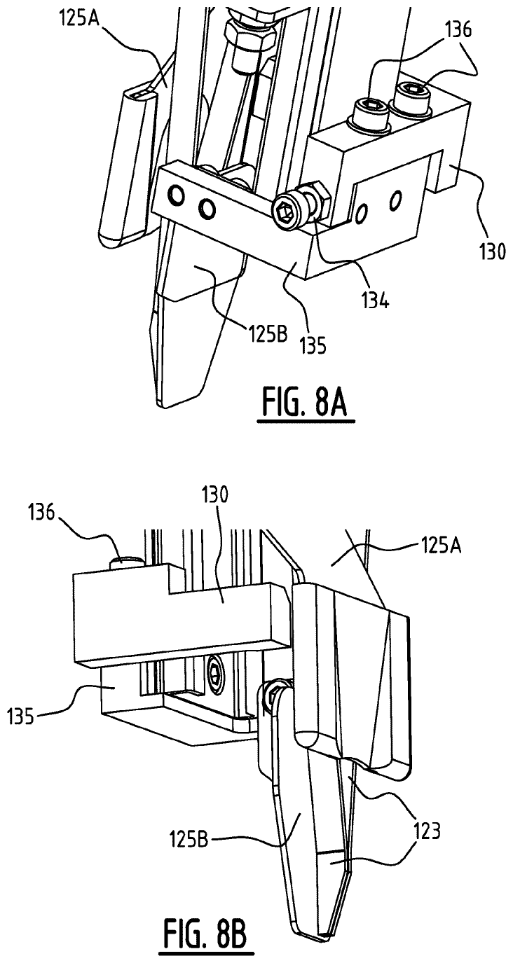

FIGS. 8A-B show details of an embodiment of a device for processing plant cuttings.

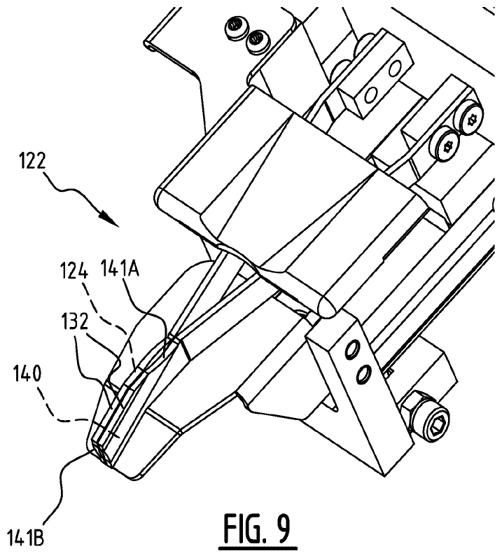

FIG. 9 shows a details of an embodiment of a device for processing plant cuttings.

FIG. 1 shows an embodiment of a system 108 for processing plant cuttings 102. The processing of plant cuttings 102 can comprise of picking up plant cuttings from a pick-up surface 101 and placing these plant cuttings 102 in a ground.

Plant cuttings 102 can for instance come from a previous cultivating step or from a processing step such as manually or mechanically slicing or cutting off parts of a plant. Plant cuttings 102 can be supplied by means of a supply means such as a conveyor belt. The plant cuttings 102 can be in different mutual orientations while being supplied.

The device 120 described below is particularly advantageous in picking up of plant cuttings 102 when the plant cuttings lie on a pick-up surface 101 which does not co-displace or deform to any significant extent in vertical direction, so that pick-up surface 101 limits the movement of plant cutting 102 during picking up. It is possible to pick up plant cuttings 102 while the pick-up surface 101 moves in horizontal direction, for instance if this pick-up surface 101 is a conveyor belt.

A plant cutting 102 is elongate and a plurality of portions of a plant cutting 102 can be distinguished. A plant cutting 102 comprises a first outer end 103; a middle portion 104; and a second outer end 105. The first outer end 103 is often the most vulnerable portion of the plant cutting 102, for instance because there is more foliage here than on the other portions. The middle portion 104 and second outer end of plant cutting 102 often form part of the stem of plant cutting 102. It is favourable to grip plant cutting 102 by the middle portion 104 and/or the second outer end 105.

During placing the second outer end 105 of plant cutting 102 must be directed downward. A plant cutting 102 can be straight or can be curved. When picking up a plant cutting 102, particularly a curved plant cutting 102, it may occur that the second outer end 105 is not oriented straight in the direction of the free outer end V. This impedes placing of plant cutting 102. A second outer end 105, which is not oriented straight in the direction of the free outer end V during gripping, will usually protrude upward outside the gripping fingers 102 in the Y-dimension to some extent.

The placing of plant cuttings takes place in a ground 107, for instance a grow medium such as soil. This ground 107 can be contained in a growing container 106 such as a tray or channel. The growing container 106 can divide the ground 107 into separate volumes, these each defining one or more positions for placing of plant cuttings 102. Growing containers can be displaced by means of throughfeed means such as a chain conveyor.

The device 120 described below is particularly advantageous in placing of plant cuttings 102 in a ground 107 which is deep and loose enough for placing the plant cuttings 102 in ground 107 up to some depth along the middle portion 104. Setting down the plant cuttings 102, or placing the plant cuttings 102 in a less deep ground, or suspended without ground in a growing container, is however also possible with such a device 120.

When placing plant cuttings 102 in a ground 107 it is highly desirable for this ground 107 to be somewhat sticky and/or heavy. This ensures that plant cutting 102 can be placed firmly, and limits contamination of the surrounding area. If the ground 107 is soil or a similar substance, this can be the case because the soil is wet, preferably saturated with moisture. This can be done by supplying wet soil and/or by moistening the soil before placing.

The processing of plant cuttings 102 can be automated wholly or partially by means of a system 108 such as a cutting insertion machine. The embodiment of such a system 108 shown in FIG. 1 comprises displacing means 109, for instance one or more robot arms 109 which are configured to displace plant cuttings 102 between a pick-up position and a destination position. A displacing means 109 of the system 108 can comprise one or more pick-up and planting heads 112, for instance one or more units of the device 120 described in the continuation of this description. These pick-up and planting heads 112 are preferably located at a free outer end of displacing means 109 and can be arranged in fixed or modular manner.

System 108 can also comprise observation means 110, for instance sensors such as cameras for the purpose of observing the plant cuttings 102 and/or for operation of the displacing means 109. Optional cameras can be colour cameras. The observations by observation means 110 can then be shown to a user by means of a screen (not shown) and/or be processed by image processing software for automatic recognition of plant cuttings 102.

The system 108 further comprises energy supply means 111, for instance a connection to the mains electricity, a generator and/or a battery. System 108 additionally comprises control means 113. The control means 113 can comprise a processor and memory, and/or a connection for an external computer system. Control means 113 can also comprise software for system 108, for instance software for automatic recognition of plant cuttings 102.

Control means 113 can be configured to control system 108 fully automatically, for instance on the basis of observations by the observation means 110, or to have system 108 be controlled wholly by external input, for instance from an external control system or by a human operator, or semi-automatically by a mixture of its own control and external control. Control means 113 can be configured to switch between modes for automatic, semi-automatic and/or external control.

It can be favourable to set up or calibrate the system 108 before use for specific types of plant cutting 102 to be processed, for instance plant cuttings of a specific plant species or plant variety. This can for instance entail control means 113 being set to control the system 108 to perform determined movements with a specific distance, force and/or speed, and/or software for automatic recognition of plant cuttings 102 being set to recognize a specific species of plant cutting 102 to be processed, for instance in that the software is automatically learning and/or being trained. It is also possible to adjust the relative position, the size and/or the shape of the gripping fingers 123 and/or guide elements 125 per type of plant cutting 102 to be processed. For this adjusting the gripping fingers 123 and/or the first and/or second guide element 125A, 125B can be arranged releasably and replaceably, for instance by means of screws.

FIG. 2 shows an embodiment of a method for processing plant cuttings 102.

The processing of plant cuttings 102 comprises of picking up 201 a plant cutting 102. The picking up 201 of a plant cutting 102 can comprise of gripping and then holding the plant cutting 102. This picking up 201 can take place by means of a device 120 which is located at a pick-up position in the vicinity of the plant cutting 102 during the picking up.

The processing of plant cuttings 102 can comprise of displacing 202 the plant cutting 102 from the pick-up position to a destination position. This displacing 202 can be done by means of a displacing means 109 of a system 108, which holds the plant cutting 102. An alternative is that the plant cutting 102 is held substantially at the same position and a ground 107 or growing container 106 for placing of plant cutting 102 is displaced toward this position. Another alternative is for plant cutting 102 to be placed at the same position as where it was picked up, for instance in a ground 107. Combining a plurality of these alternatives is also possible.

The processing of plant cuttings comprises of placing 203 a plant cutting 102. The placing 203 of a plant cutting 102 can comprise of releasing a held plant cutting 102. This placing can be done by a device 120 which is located at a destination position and holds a plant cutting 102 during placing.

The processing of plant cuttings can comprise of displacing back 204 a displacing means 109 of a system 108 from the destination position to a pick-up position. An alternative is for one or more new plant cuttings 102 to be processed to be supplied. Combining a plurality of these alternatives is also possible.

The processing of plant cuttings 102 can comprise of the steps of picking up 201, optional displacing 202, placing 203 and optional displacing back 204 being performed repeatedly. These steps can be performed for a plurality of plant cuttings 102 simultaneously, for instance by means of a plurality of systems, a plurality of displacing means 109 of a system 108, or a plurality of pick-up and planting heads 112 of a displacing means 109. The steps can be performed synchronously for a plurality of plant cuttings 102, or simultaneously but substantially independently of each other.

FIGS. 3A-F show embodiments of a device 120 for processing plant cuttings during a method for processing plant cuttings.

FIGS. 3A and 3B show a bottom view. FIGS. 3C-3F show a side view. FIGS. 3A and 3C show an imaginary coordinate system with an X-dimension, Y-dimension and Z-dimension relative to the device 120. Device 120 comprises a free outer end V in the Z-dimension. Device 120 can form part of a system 108 for processing plant cuttings.

The shown embodiment of a device 120 comprises a gripper 122 and guide elements 125. These elements can be mounted on a collective base element 121. The gripper 122 and guide elements 125 are preferably made of a stainless metal, although other materials such as a hard plastic can also be used.

Gripper 122 comprises a plurality of gripping fingers 123 for gripping a plant cutting 102, for instance two gripping fingers 123. The gripping fingers 123 can be elongate and gripper 122 defines between determined surfaces 124 of gripping fingers 123 a location where a plant cutting 102 can be gripped. The surfaces 124 are preferably flat or provided with a cavity 140 for receiving a plant stem of a gripped plant cutting 102, for instance an elongate cavity in the Z-dimension from the one to the other side of the surface 124 of one or more gripping fingers 123.

FIG. 9 shows a detail of an embodiment of a gripper 122 wherein the surfaces 124 are provided with a cavity 140 extending substantially in the Z-dimension and running from one side to another side through the whole contact surface of the surfaces 124, so that openings 141A, 141B are formed at two mutually opposite locations. The cavity 140 has a cross-section which is small enough to grip plant cuttings 102, but large enough to ensure that the pressure is distributed better over the periphery of the plant cutting 102.

In the shown embodiment the surfaces 124 of the two gripping fingers 123 lie opposite each other in the X-dimension. Positioned at right angles to the X-dimension is a Y-dimension. During picking up the pick-up surface 101 can support the plant cutting 102 in vertical direction, this facilitating the picking up.

While picking up a plant cutting 102, device 120 preferably approaches the pick-up surface 101 at a predetermined angle. This is easier when at least one side surface 132 of gripping fingers 123 lies parallel opposite pick-up surface 101, or even thereagainst. In order to enable this the gripping fingers 123 can be provided with a downward inclining side surface 132 at an angle corresponding with the predetermined approach angle.

Such a side surface 132 is visible and designated in FIG. 3A and FIG. 7A. The shown downward inclining side surface 132 is formed as if a corner of the gripping fingers 123 at the free outer end V of device 120 has been cut slantwise. Downward inclining side surfaces 132 are also visible in FIG. 9. The cavity 140 preferably runs parallel to downward inclining side surfaces 132. This can be advantageous while picking up a plant cutting 102 which lies with the middle portion 104 parallel to a pick-up surface 101.

The gripper 122 is configured to move, i.e. to close into a closed position for gripping and holding a plant cutting 102 and to open into a partially or wholly opened position for releasing a plant cutting 102. For this purpose the gripper 122 is provided with one or more actuators 131, for instance pneumatic or hydraulic actuators and/or electric cylinders, for instance a single actuator 131 for both closing and opening. The one or more actuators 131 are preferably configured to be controlled electronically. The air pressure of a pneumatic actuator can further optionally be controlled by means of an air pressure control valve. The closing of gripper 122 can comprise of an actuator 131 being controlled to move the gripping fingers 123 toward each other. Opening of gripper 122 can comprise of an actuator 131 being controlled to move the gripping fingers 123 apart, or merely of an actuator 131 being controlled to reduce or remove a force which makes the gripping fingers 123 move toward each other.

FIGS. 3D-F show a limiter 130. This has been omitted in FIGS. 3A-3C for the sake of clarity. A limiter 130 can for instance take the form of a plate or block. Such a limiter can be arranged on one or more outer sides of the gripper 122 in the X-dimension.

A limiter 130 limits the opening of gripper 122 by stopping a respective gripping finger 123 in an opening movement. This limits the distance between the gripping fingers 123 to an opened position without gripping fingers 123 having to be actuated to an exact position. This is favourable especially in combination with one or more pneumatic or hydraulic actuators 131, or to prevent springing back upon contact with the ground 106. This opened position can be a limited opened position in which the distance between the gripping fingers 123 is smaller than in a fully opened position which can be reached when gripping fingers 123 are moved apart by an actuator 131.

In the shown embodiment the guide elements 125 are located adjacently of gripping fingers 123 and are configured such that the guide element and the gripping fingers 123 can be moved closely alongside each other, for instance in that the guide elements 125 are embodied with a flat surface 126 on the side of the gripping fingers 123.

Guide elements 125 can lie against gripping fingers 123 or a short distance from gripping fingers 123, for instance be positioned 0.5 or 1.0 mm from gripping fingers 123. In the first case it is important for surface 126 of gripping fingers 123 to be smooth in order to limit friction. In the second case it is important for the distance to be small enough to prevent portions of a plant cutting 102 from coming to lie between guide element 125 and one or more gripping fingers 123.

Guide elements 125 can be embodied as plates. A guide element 125 can be curved, be provided with recesses and/or be constructed from a plurality of parts in order to save on material use and/or in order to prevent parts of guide element 125 from getting in the way during a movement.

A first guide element 125A is located on a first side of gripper 122 in the Y-dimension, outside gripping fingers 123. A second guide element 125B is located on a second side of gripper 122 in the Y-dimension opposite the first side, outside gripping fingers 123. Guide elements 125 are configured to guide a plant cutting 102.

In favourable embodiments the limiter 130 is mounted at fixed position in the Z-dimension relative to the second guide element 125B. The second guide element 125B is positioned further toward the free outer end V of device 120 during picking up 201 of a plant cutting 102 than during placing 203 of the plant cutting 102, so that limiter 130 does limit the opening movement, or limits it more, during placing 203 and does not limit it, or limits it less, during picking up 201.

A resting edge 127 at the outer end of the first guide element 125A in the Z-dimension toward the free outer end V of device 120 will particularly come into contact with plant cuttings 102. It is advantageous for resting edge 127 to be configured to protect plant cuttings 102 against damage in that less pressure is exerted on plant cutting 102, particularly on the first outer end 103 or the middle portion 104, in use of the device 120.

Resting edge 127 can be configured to limit or prevent damage to plant cuttings 102 by giving at least a part of this resting edge 127 a rounded form, for instance by tumbling it. Other measures are also possible for embodying the resting edge 127 to protect plant cutting 102. These are shown in for instance FIGS. 4A, 7A-F and 4B. The different measures can be combined with each other.

FIG. 4A shows an embodiment of a guide element 125A, the resting edge 127 of which is configured to limit or prevent damage to plant cuttings 102 in that a part of the resting edge 127 is embodied in or covered with a piece of more flexible material 129 than the rest of the guide element 125A, such as plastic, rubber or silicone. Alternatively, the whole resting edge 127 can be embodied in this way.

FIGS. 7A-F show a first guide element 125A with a resting edge 127 wherein the piece of more flexible material 129 comprises a channel for receiving and protecting the first outer end 103 of plant cutting 102.

FIG. 4B shows an embodiment of a guide element 125, the resting edge 127 of which is configured to limit or prevent damage to plant cuttings 102 in that it is provided with a recess 128 at the location which comes into contact with the plant cutting 102 during one or more steps of the use of device 120. The recess 128 is U-shaped in FIG. 4B, although other forms are also possible. FIG. 5A shows an embodiment of a method for picking up 201 plant cuttings 102. This method can be performed using the above described device 120.

The method comprises of positioning 301 gripping fingers 123 of device 120 on either side of a first, middle portion 104 of a plant cutting 102. FIG. 3A shows a bottom view of a device 120 wherein the gripping fingers 123 are positioned on either side of a first, middle portion 104 of a plant cutting. When picking up the plant cutting 102 from a pick-up surface 101, it is favourable for the device to be positioned with the Z-dimension parallel to or at an angle of less than 45° with a pick-up surface 101. It is also favourable for gripping fingers 123 to be positioned such that the second outer end 105 does not protrude beyond gripping fingers 123 in the direction of the free outer end V. The plant cutting 102 is thus protected against snapping during the subsequent placing.

It is favourable to move gripping fingers 123 open by means of an actuator 131 prior to and/or during positioning 301 of the gripping fingers 123 round plant cutting 102 in order to reach an opened position, preferably a fully opened position.

The method comprises of positioning 302 a first guide element 125A of device 120 on a first outer side of gripper 122 in order to make space on the first outer side of gripper 122 for a first outer end 103 of a plant cutting 102 protruding between gripping fingers 123, and simultaneously prevent a second outer end 105 of plant cutting 102 from ending up between gripping fingers 123.

This relative positioning 302 of the first guide element 125A can be done by moving the first guide element 125A and gripper 122 relative to each other such that the first guide element 125A is displaced in the Z-dimension from a first position P1 adjacently of gripper 122 toward a second position P2, wherein this second position P2 is located further away from the free outer end V of device 120.

The method comprises of positioning 303 a second guide element 125B of the device on a second outer side of gripper 122 in order to rotate and/or displace the second outer end and/or in order to prevent rotation and/or displacement of the second outer end.

This positioning 303 of the second guide element 125B can be done by moving the second guide element 125B and gripper 122 relative to each other such that the second guide element 125B is displaced in the Z-dimension from a third position P3 adjacently of gripper 122 toward a fourth position P4, wherein this fourth position P4 is located further toward the free outer end V of device 120.

This relative positioning 303 of the second guide element 125B can take place before, during or after the step of the relative positioning 301 of the gripping fingers 123.

Moving or holding the second guide element 125B against a portion of the plant cutting 102, for instance the outer end 105, enables the plant cutting to be displaced or rotated or conversely enables rotation or displacement to be prevented. In the subsequent placing of the plant cutting 102 it is advantageous to displace or rotate the plant cutting 102, or prevent rotation or displacement thereof, such that the outer end 105 points toward the free outer end V in the Z-dimension.

The different positions P1, P2, P3, P4 of the guide elements can be preset per type of plant cutting 102, for instance on the basis of a size and/or shape of the plant cutting 102. Examples of such positions are designated in FIGS. 6A and 6B.

Device 120 is configured with actuators for moving the gripper 122 and the first and second guide element 125A, 125B relative to each other between positions P1, P2, P3, P4, for instance by means of a respective actuator per guide element 125A, 125B. Device 120 is preferably provided with one or more actuators which can be controlled such that one or more, preferably all, positions P1, P2, P3, P4 can be selected per individual plant cutting, such as one or more electric linear actuators. This for instance makes it possible to insert different plant cuttings to different depths. The depth can for instance be chosen here on the basis of information from the observation means 110 (for instance camera images of the plant cutting in question).

The control means 113 can be configured to control device 120 on the basis of a preset plant depth determined from observations by observation means 110, such as a length of a plant cutting 102 observed by observation means 110 or of a determined part of the plant cutting (for instance the length of the part of a determined plant cutting relative to the first runner thereof). The desired insertion depth can for instance be determined subject to the length determined from camera images, and said (end) position of the guide element can be set on the basis of the desired insertion depth.

Control means 113 can for instance also be configured to automatically select a respective pick-up position between the first outer end 103 and second outer end 105 for each individual plant cutting 102, and/or to automatically respectively select one or more, preferably all, positions P1, P2, P3, P4 per individual plant cutting.

Control means 113 can for instance be configured to select respective pick-up positions or positions P1, P2, P3, P4 of plant cuttings 102 such that different plant cuttings 102 are placed substantially equally deep into the ground irrespective of their individual length, or such that different plant cuttings 102 protrude equally far above the ground of placing irrespective of their individual length.

The method comprises of closing 304 the gripper 122. FIG. 3B shows a device 120 with the gripper 122 in closed position.

Once gripper 122 is in closed position the second guide element 125B can be positioned in the third position P3 again at any moment. By doing this prior to the placing 203 of plant cutting 102 it can be prevented that the placing 203 is impeded.

FIG. 5B shows an embodiment of a method for placing 203 plant cuttings 102 in a ground 106. This method can be performed using the above described device 120.

The method can comprise of moistening 401 the ground, preferably of saturating the ground 106 with moisture, prior to pressing the gripper 122 into the ground 106. As already described above, it is highly desirable for ground 106 to be wet.

The method comprises of pressing 402 a gripper 122 of device 120 into the ground 106 while gripper 122 holds the plant cutting 102. FIG. 3C shows a side view of a device 120 which is positioned with the Z-dimension at right angles to, or at an angle of more than 45 degrees with, the surface of a ground 106, wherein the free outer end V is directed toward the ground 106.

The method comprises of opening 403 the gripper 122. The plant cutting is released here. FIG. 3D shows a device 120 wherein the gripper 122 is in a partially opened state. The difference with the closed state amounts here to between 0.5 and 1 mm, although the use of different embodiments of components such as gripping fingers 123 enables variation per type of plant cutting 102. The limiter 130 here limits the opening of gripper 122.

The method comprises of moving 404 the gripper 122 out of ground 106 and away from plant cutting 102, and simultaneously displacing gripper 122 and a first guide element 125A relative to each other for the purpose of stopping plant cutting 102 with the first guide element 125A. The first guide element 125A for instance ends up in the above discussed first position P1 here. FIG. 3E shows a device 120 wherein the gripper 122 has already moved partially out of ground 106.

FIG. 3F shows a device 120 wherein the gripper 122 has moved out of the ground 106 and away from the plant cutting 102. In FIG. 3F the first guide element 125A is shown in broken lines and transparently in order to show the gripper more fully. In FIG. 7F the first guide element 125A of another embodiment is shown non-transparently in a similar state. In an embodiment the simultaneous moving away of gripper 122 and stopping of plant cutting 102 can be done by moving the first guide element 125A in the direction of the free outer end V to the first position P1 synchronously with the moving away of gripper 122, so that the first guide element 125A remains in the same position relative to the ground.

FIGS. 8A and 8B show details of an embodiment of a device for processing plant cuttings. It can be seen that the limiter 130 is here arranged on the other side in the X-dimension. Both placements are possible.

The shown embodiment of a limiter 130 is provided with adjusting means 134 for determining and, if necessary, changing the position of limiter 130 in the X-dimension. Changing this position enables the distance between the gripping fingers in the opened position to be determined. As described above, the limiting of the distance between the gripping fingers also depends on the position of the second guide element 125B.

In the shown embodiment the limiter 130 is positioned at a fixed position in the Z-dimension and at a predetermined, adjustable position in the X-dimension relative to the second guide element 125B.

Adjusting means 134 can be embodied in different ways, but in the shown case comprise an adjusting screw which is configured to mount limiter 130 at different positions on an intermediate element 135, which in turn is mounted on the second guide element 125B. Such an intermediate element 135 need not be present: the adjusting means 134 can also be configured to mount the limiter 130 directly on the second guide element 125B at different positions, or to control the mutual distance in other manner.

In order to lock the position when adjusting means 134 are not in use the limiter is further provided with locking means 136, in this case locking screws. These locking means 136 are embodied to be fastened or released in order to respectively lock the position of limiter 130 and enable adjustment thereof.

1. A device for processing a plurality of plant cuttings, the device comprising:
a gripper comprising gripping fingers configured to grip, hold, and release a plant cutting of the plurality of plant cuttings;
a first guide positioned on a first outer side of the gripper; and
a second guide positioned on a second outer side of the gripper opposite the first outer side,
wherein the first guide and the gripping fingers of the gripper are configured to be displaced relative to each other, and the second guide and the gripping fingers of the gripper are configured to be displaced relative to each other independently thereof.

2. The device according to claim 1, wherein the gripping fingers lie opposite each other in a first dimension,
wherein the first guide and the second guide are disposed on the outer side of the gripper in a second dimension, which lies substantially at right angles to the first dimension, and
wherein the first guide and the second guide are configured to move, independently of each other and the gripper, relative to each other in a third dimension which lies substantially at right angles to the first dimension and the second dimension.

3. The device according to claim 2, wherein the gripping fingers are configured to be displaced in the first dimension between a closed position to grip and hold the plant cutting and an opened position to release the plant cutting.

4. The device according to claim 3, further comprising an actuator configured to displace the gripping fingers between the closed position and the opened position.

5. The device according to claim 3, further comprising a limiter configured to limit displacement in the first dimension of at least one of the gripping fingers to limit a distance between the gripping fingers in the opened position.

6. The device according to claim 5, wherein the limiter is mounted at a predetermined fixed position relative to the second guide,
wherein the limiter is provided with an adjustment system configured to change the predetermined fixed position.

7. The device according to claim 1, wherein the gripping fingers which are provided at a respective outer end thereof with respective surfaces to grip and hold therebetween the plant cutting resting on a ground,
wherein the surfaces are flat or are provided with a cavity configured to receive a plant stem of the plant cutting gripped by the gripping fingers.

8. The device according to claim 1, wherein one or more of the first guide and the second guide comprises a substantially flat plate which is provided with an elongate resting edge.

9. The device according to claim 1, wherein one or more of an outer end of the first guide and an outer end of the second guide is wider than a distance between the gripping fingers when the gripper is in opened position.

10. (canceled)

11. The device according to claim 1, wherein the first guide is configured to separate a first outer end of the plant cutting from the gripping fingers when the gripper grips the plant cutting.

12. The device according to claim 1, wherein the second guide is configured to one or more of: (i) rotate and/or displace a second outer end of the plant cutting, and (ii) prevent rotation and/or displacement of the second outer end, when the gripper grips the plant cutting.

13. The device according to claim 1, wherein the gripper is configured to press into a ground while the gripper holds the plant cutting to place the plant cutting in the ground.

14. The device according to claim 1, wherein the first guide is configured to move relative to the gripper when the gripper has placed the plant cutting in a ground to stop the plant cutting while the gripper moves away from the plant cutting.

15. The device according to claim 14, wherein the first guide moves relative to the gripper to stop the plant cutting by the first guide being held at a substantially fixed position relative to the ground while the gripper moves away from the ground.

16. The device according to claim 15, wherein the first guide is held at a substantially fixed position relative to the ground
by an outer end of the first guide one or more of supporting on and pushing against one or more of the plant cutting, the ground, and a ground container.

17. The device according to claim 1, wherein a resting edge of the first guide is configured to limit or prevent damage to the plant cuttings by being one or more of: (i) rounded, (ii) embodied at least partially in a flexible material, and (iii) provided with a recess configured to receive a portion of the plant cutting.

18. The device according to claim 1, further comprising a base on which the gripper, the first support, and the second support are mounted.

19. The device according to claim 18, wherein one or more of: (i) the gripping fingers are configured to be placed round the plant cutting prior to the plant cutting being gripped, and (ii) the gripper is configured to move away from the plant cutting after the plant cutting has been released, by one or more of: (i) the gripper moving relative to the base, and (ii) the gripper moving by moving the base and simultaneously holding the gripper in a fixed position relative to the base.

20. The device according to claim 18, wherein the gripper and at least one of the first and second guides are configured to be displaced relative to each other by one or more of: (i) the respective guide moving relative to the base and the gripper being simultaneously held in a fixed position relative to the base, and (ii) the gripper moving relative to the base and the respective guide being simultaneously held in a fixed position relative to the base, and (iii) the gripper moving relative to the base and the respective guide simultaneously moving relative to the base element.

21. (canceled)

22. A system for processing plant cuttings comprising:
a displacement system; and
at least one device according to claim 1 mounted on the displacement system, the displacement system being configured to displace the at least one device between a pick-up position and a destination position.

23. (canceled)

24. A method for picking up the plant cutting by the device according to claim 1, the method comprising:
positioning the gripping fingers of the device on either side of the plant cutting;
positioning the first guide of the device on the first outer side of the gripper in order to separate a first outer end of the plant cutting from the gripping fingers;
positioning the second guide of the device on the second outer side of the device to one or more of: (i) rotate and/or displace the second outer end, and (ii) prevent rotation and/or displacement of the second outer end; and
closing the gripper.

25. The method according to claim 24, wherein, during picking up, the first outer side is underside of the gripper and the second outer side is an upper side of the gripper, so that the first guide is held along a bottom and the second guide is held along a top of at least a portion of the gripping fingers.

26. The method for placing the plant cutting in a ground by the device according to claim 1, the method comprising:
pressing the gripper of the device into the ground while the gripper holds the plant cutting;
opening the gripper; and
moving the gripper out of the ground and away from the plant cutting, and simultaneously displacing the gripper and the first guide relative to each other to stop the plant cutting with the first guide.

27. (canceled)

28. (canceled)
